(19) United States
(12) Patent Application Publication
(10) Pub. No.: US 2023/0056913 A1
(43) Pub. Date: Feb. 23, 2023

(54) SPLICING STRIPLINES

(71) Applicant: International Business Machines Corporation, Armonk, NY (US)

(72) Inventors: Donald Stimson Bethune, San Jose, CA (US); Charles Thomas Rettner, San Jose, CA (US)

(21) Appl. No.: 17/445,264

(22) Filed: Aug. 17, 2021

(51) Int. Cl. H01P 3/08; H01P 11/00

(52) U.S. Cl. CPC H01P 3/08; H01P 11/003

(57) ABSTRACT

An embodiment of the invention may include a spliced stripline structure. The structure may include a first stripline including a signal line located between a top dielectric and a bottom dielectric. The top dielectric is in contact with a top ground plane. The bottom dielectric is in contact with a bottom ground plane. The structure may include a second stripline including a signal line located between a top dielectric and a bottom dielectric. The top dielectric is in contact with a top ground plane. The bottom dielectric is in contact with a bottom ground plane. The structure may include a joined portion connecting the first stripline to the second stripline. The joined portion the first stripline includes the bottom ground plane, the bottom dielectric, and at least one signal line. The joined portion the first stripline includes the bottom ground plane, the bottom dielectric, and at least one signal line.

### STATEMENT REGARDING FEDERALLY SPONSORED RESEARCH OR DEVELOPMENT

This invention was made with U.S. Government support. The U.S. Government has certain rights in this invention.

### BACKGROUND

The present invention relates to microelectronics fabrication, and more specifically, to fabrication of flex stripline.

A stripline is a transverse electromagnetic transmission line. The stripline uses a flat strip of metal which is sandwiched between two parallel ground planes. The insulating material of the substrate forms a dielectric. The width of the strip, the thickness of the substrate and the relative permittivity of the substrate determine the characteristic impedance of the strip.

### BRIEF SUMMARY

An embodiment of the invention may include a method of splicing striplines. The embodiment may include removing a top groundplane and a top dielectric of a first stripline. The embodiment may include removing a top groundplane and a top dielectric of a second stripline. The embodiment may include applying a joining material to at least one signal line of the first stripline. The embodiment may include aligning the at least one signal line of the first stripline to at least one signal line of the second stripline. The embodiment may include joining the first stripline to the second stripline. This may enable combining commercially available flex striplines with a stripline containing non-standard materials, or enable fabricating sufficient length of striplines containing non-standard materials, to serve as a connection to devices operating in conditions requiring specialty systems.

In an embodiment of the method a material of the top ground plane of the first stripline includes copper, and a material of the top ground plane of the second stripline includes niobium. This may enable combining commercially available flex striplines with a stripline containing non-standard materials to serve as a connection to devices operating in conditions requiring specialty systems.

In an embodiment of the method a material of the top ground plane of the first stripline includes niobium, and a material of the top ground plane of the second stripline includes niobium. This may enable fabricating sufficient length of striplines containing non-standard materials to serve as a connection to devices operating in conditions requiring specialty systems.

In an embodiment of the method a material of the at least one signal line of the first stripline includes copper, a material of the at least one signal line of the second stripline includes niobium. This may enable combining commercially available flex striplines with a stripline containing non-standard materials to serve as a connection to devices operating in conditions requiring specialty systems.

In an embodiment of the method a material of the at least one signal line of the first stripline includes niobium, and a material of the at least one signal line of the second stripline includes niobium. This may enable fabricating sufficient length of striplines containing non-standard materials to serve as a connection to devices operating in conditions requiring specialty systems.

In an embodiment of the method the joining material includes a material selected from a group consisting of Sn, In, and Pb. This may enable combining commercially available flex striplines with a stripline containing non-standard materials, or enable fabricating sufficient length of striplines containing non-standard materials, to serve as a connection to devices operating in conditions requiring specialty systems.

In an embodiment of the method joining the first stripline to the second stripline further includes fusing a portion of the first dielectric with a portion of the second dielectric. This may enable combining commercially available flex striplines with a stripline containing non-standard materials, or enable fabricating sufficient length of striplines containing non-standard materials, to serve as a connection to devices operating in conditions requiring specialty systems.

In an embodiment of the method a surface of an interface between the first stripline and the second stripline is substantially parallel to the bottom ground plane of the first stripline and the bottom ground plane of the second stripline. This may enable combining commercially available flex striplines with a stripline containing non-standard materials, or enable fabricating sufficient length of striplines containing non-standard materials, to serve as a connection to devices operating in conditions requiring specialty systems.

In an embodiment of the method a surface of an interface between the first stripline and the second stripline is an acute angle with respect to the bottom ground plane of the first stripline and the bottom ground plane of the second stripline. This may enable combining commercially available flex striplines with a stripline containing non-standard materials, or enable fabricating sufficient length of striplines containing non-standard materials, to serve as a connection to devices operating in conditions requiring specialty systems.

An embodiment of the invention may include a spliced stripline structure. The structure may include a first stripline including a signal line located between a top dielectric and a bottom dielectric, wherein the top dielectric is in contact with a top ground plane, and wherein the bottom dielectric is in contact with a bottom ground plane. The structure may include a second stripline including a signal line located between a top dielectric and a bottom dielectric, wherein the top dielectric is in contact with a top ground plane, and wherein the bottom dielectric is in contact with a bottom ground plane. The structure may include a joined portion connecting the first stripline to the second stripline, wherein at the joined portion the first stripline includes the bottom ground plane, the bottom dielectric, and at least one signal line, and wherein at the joined portion the first stripline includes the bottom ground plane, the bottom dielectric, and at least one signal line. This may enable combining commercially available flex striplines with a stripline containing non-standard materials, or enable fabricating sufficient length of striplines containing non-standard materials, to serve as a connection to devices operating in conditions requiring specialty systems.

An embodiment of the structure may include a material of the top ground plane of the first stripline includes copper, and wherein a material of the top ground plane of the second stripline includes niobium. This may enable combining commercially available flex striplines with a stripline containing non-standard materials to serve as a connection to devices operating in conditions requiring specialty systems.

An embodiment of the structure may include a material of the top ground plane of the first stripline includes niobium, and wherein a material of the top ground plane of the second stripline includes niobium. This may enable fabricating sufficient length of striplines containing non-standard materials to serve as a connection to devices operating in conditions requiring specialty systems.

An embodiment of the structure may include a material of the at least one signal line of the first stripline includes copper, and wherein a material of the at least one signal line of the second stripline includes niobium. This may enable combining commercially available flex striplines with a stripline containing non-standard materials to serve as a connection to devices operating in conditions requiring specialty systems.

An embodiment of the structure may include a material of the at least one signal line of the first stripline includes niobium, and wherein a material of the at least one signal line of the second stripline includes niobium. This may enable fabricating sufficient length of striplines containing non-standard materials to serve as a connection to devices operating in conditions requiring specialty systems.

An embodiment of the structure may include a joining material located between the at least one signal line of the first stripline and the at least one signal line of the second stripline. This may enable combining commercially available flex striplines with a stripline containing non-standard materials, or enable fabricating sufficient length of striplines containing non-standard materials, to serve as a connection to devices operating in conditions requiring specialty systems.

An embodiment of the structure may include the joining material includes a material selected from a group consisting of Sn, In, and Pb. This may enable combining commercially available flex striplines with a stripline containing non-standard materials, or enable fabricating sufficient length of striplines containing non-standard materials, to serve as a connection to devices operating in conditions requiring specialty systems.

An embodiment of the structure may include a fused joint between the top dielectric of the first stripline and a top dielectric of the second stripline. This may enable combining commercially available flex striplines with a stripline containing non-standard materials, or enable fabricating sufficient length of striplines containing non-standard materials, to serve as a connection to devices operating in conditions requiring specialty systems.

An embodiment of the structure may include a surface of an interface between the first stripline and the second stripline is substantially parallel to the bottom ground plane of the first stripline and the bottom ground plane of the second stripline. This may enable combining commercially available flex striplines with a stripline containing non-standard materials, or enable fabricating sufficient length of striplines containing non-standard materials, to serve as a connection to devices operating in conditions requiring specialty systems.

An embodiment of the structure may include surface of an interface between the first stripline and the second stripline is an acute angle with respect to the bottom ground plane of the first stripline and the bottom ground plane of the second stripline. This may enable combining commercially available flex striplines with a stripline containing non-standard materials, or enable fabricating sufficient length of striplines containing non-standard materials, to serve as a connection to devices operating in conditions requiring specialty systems.

An embodiment of the structure may include the top ground plane of the first stripline is in contact with the bottom contact of the second stripline, and wherein the bottom ground plane of the first stripline is in contact with the top contact of the second stripline. This may enable combining commercially available flex striplines with a stripline containing non-standard materials, or enable fabricating sufficient length of striplines containing non-standard materials, to serve as a connection to devices operating in conditions requiring specialty systems.

### BRIEF DESCRIPTION OF THE DRAWINGS

FIG. 1A-1C represents a cross sectional view depicting a stripline, according to an example embodiment;

FIG. 2A-2C represents a cross sectional view depicting a stripline following removal of a first portion, according to an example embodiment;

FIG. 3A-3C represents a cross sectional view depicting a stripline following removal of a second portion, according to an example embodiment;

FIG. 4A-4C represents a cross sectional view depicting following deposition of a joining material, according to an example embodiment;

FIG. 5A-5C represents a cross sectional view depicting aligning a first stripline with a second stripline, according to an example embodiment;

FIG. 6A-6B represents a cross sectional view depicting joining a first stripline to a second stripline, according to an example embodiment; and

FIG. 7A-7B represents a cross sectional view depicting a fused stripline, according to an example embodiment.

Elements of the figures are not necessarily to scale and are not intended to portray specific parameters of the invention. For clarity and ease of illustration, dimensions of elements may be exaggerated. The detailed description should be consulted for accurate dimensions. The drawings are intended to depict only typical embodiments of the invention, and therefore should not be considered as limiting the scope of the invention. In the drawings, like numbering represents like elements.

### DETAILED DESCRIPTION

Exemplary embodiments now will be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will convey the scope of this disclosure to those skilled in the art. In the description, details of well-known features and techniques may be omitted to avoid unnecessarily obscuring the presented embodiments.

For purposes of the description hereinafter, terms such as “upper”, “lower”, “right”, “left”, “vertical”, “horizontal”, “top”, “bottom”, and derivatives thereof shall relate to the disclosed structures and methods, as oriented in the drawing figures. Terms such as “above”, “overlying”, “atop”, “on top”, “positioned on” or “positioned atop” mean that a first element, such as a first structure, is present on a second element, such as a second structure, wherein intervening elements, such as an interface structure may be present between the first element and the second element. The term “direct contact” means that a first element, such as a first structure, and a second element, such as a second structure, are connected without any intermediary conducting, insulating or semiconductor layers at the interface of the two elements. As used herein, the term “same” when used for comparing values of a measurement, characteristic, parameter, etc., such as “the same width,” means nominally identical, such as within industry accepted tolerances for the measurement, characteristic, parameter, etc., unless the context indicates a different meaning. As used herein, the terms “about,” “approximately,” “significantly, or similar terms, when used to modify physical or temporal values, such as length, time, temperature, quantity, electrical characteristics, superconducting characteristics, etc., or when such values are stated without such modifiers, means nominally equal to the specified value in recognition of variations to the values that can occur during typical handling, processing, and measurement procedures. These terms are intended to include the degree of error associated with measurement of the physical or temporal value based upon the equipment available at the time of filing the application, or a value within accepted engineering tolerances of the stated value. For example, the term “about” or similar can include a range of ±8% or 5%, or 2% of a given value. In one aspect, the term “about” or similar means within 10% of the specified numerical value. In another aspect, the term “about” or similar means within 5% of the specified numerical value. Yet, in another aspect, the term “about” or similar means within 10, 9, 8, 7, 6, 5, 4, 3, 2, or 1% of the specified numerical value. In another aspect, these terms mean within industry accepted tolerances.

For the clarity of the description, and without implying any limitation thereto, illustrative embodiments may be described using simplified diagrams. In an actual fabrication, additional structures that are not shown or described herein, or structures different from those shown and described herein, may be present without departing from the scope of the illustrative embodiments.

Differently patterned portions in the drawings of the example structures, layers, and formations are intended to represent different structures, layers, materials, and formations in the example fabrication, as described herein. A specific shape, location, position, or dimension of a shape depicted herein is not intended to be limiting on the illustrative embodiments unless such a characteristic is expressly described as a feature of an embodiment. The shape, location, position, dimension, or some combination thereof, are chosen only for the clarity of the drawings and the description and may have been exaggerated, minimized, or otherwise changed from actual shape, location, position, or dimension that might be used in actual fabrication to achieve an objective according to the illustrative embodiments.

An embodiment when implemented in an application causes a fabrication process to perform certain steps as described herein. The steps of the fabrication process are depicted in the several figures. Unless such a characteristic is expressly described as a feature of an embodiment, not all steps may be necessary in a particular fabrication process; some fabrication processes may implement the steps in different order, combine certain steps, remove or replace certain steps, or perform some combination of these and other manipulations of steps, without departing the scope of the illustrative embodiments.

The illustrative embodiments are described with respect to certain types of materials, electrical properties, structures, formations, layers orientations, directions, steps, operations, planes, dimensions, numerosity, data processing systems, environments, and components. Unless such a characteristic is expressly described as a feature of an embodiment, any specific descriptions of these and other similar artifacts are not intended to be limiting to the invention; any suitable manifestation of these and other similar artifacts can be selected within the scope of the illustrative embodiments.

The illustrative embodiments are described using specific designs, architectures, layouts, schematics, and tools only as examples and are not limiting to the illustrative embodiments. The illustrative embodiments may be used in conjunction with other comparable or similarly purposed designs, architectures, layouts, schematics, and tools.

For the sake of brevity, conventional techniques related to microelectronic fabrication may or may not be described in detail herein. Moreover, the various tasks and process steps described herein can be incorporated into a more comprehensive procedure or process having additional steps or functionality not described in detail herein. In particular, various steps in the manufacture of microelectronic devices may be well known and so, in the interest of brevity, many conventional steps may only be mentioned briefly or may be omitted entirely without providing the well-known process details.

In the following descriptions, the term length applies to dimensional characteristics along the x-axis.

In the following descriptions, the term width applies to dimensional characteristics along the y-axis.

In the following descriptions, the term thickness applies to dimensional characteristics along the z-axis.

In the interest of not obscuring the presentation of embodiments of the present invention, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is rather focused on the distinctive features or elements of various embodiments of the present invention.

Superconducting flexible stripline circuits are desirable for use in low-noise, low-temperature environments where cooling power and space are limited. While low-loss, GHz frequency range, flex circuits made with Cu metallization are highly developed and commercially available, superconducting versions are generally not. Additionally, the Cu technology is not readily extendable to exotic refractory materials such as Nb and NbTi. For such materials, more elaborate vacuum techniques can be used, but this limits the size of the parts that can be made to “wafer scale” −20-30 cm. It would be desirable to make relatively simple superconducting flex circuit structures, in sizes that can be handled in normal vacuum equipment, and to have a way to combine these structures with other superconducting or Cu flex circuit sections to make larger or more complex circuits.

Flex striplines are a common component in modern electronic systems. For example, copper flex striplines are commercially available having standard circuits already printed on them (e.g. complex interfaces, attenuator sections, other specialty components), with minimal processing required to enable proper performance. However, specialty systems may require striplines feeding operating devices that have unique electrical or mechanical characteristics that are not present in commercially available striplines. The use of such specialty systems may only require a segment of the stripline (e.g. connection to a device under test), and thus using it may require the specialty characteristics for an entire length of the stripline. Further, such specialty systems may not be commercially available, and would be created in-house using standard deposition, etching, and coating process along and processed in standard vacuum systems. Thus, the process contained below may provide an advantage of combining commercially available flex striplines, and the components contained thereon, with a stripline containing non-standard materials to serve as a connection to devices operating on such specialty systems. For example, connection of copper wiring to super conducting wiring may enable better performance, and ease of assembly, of superconducting systems by leveraging the accrued knowledge of fabricating copper electronics with superconducting circuits.

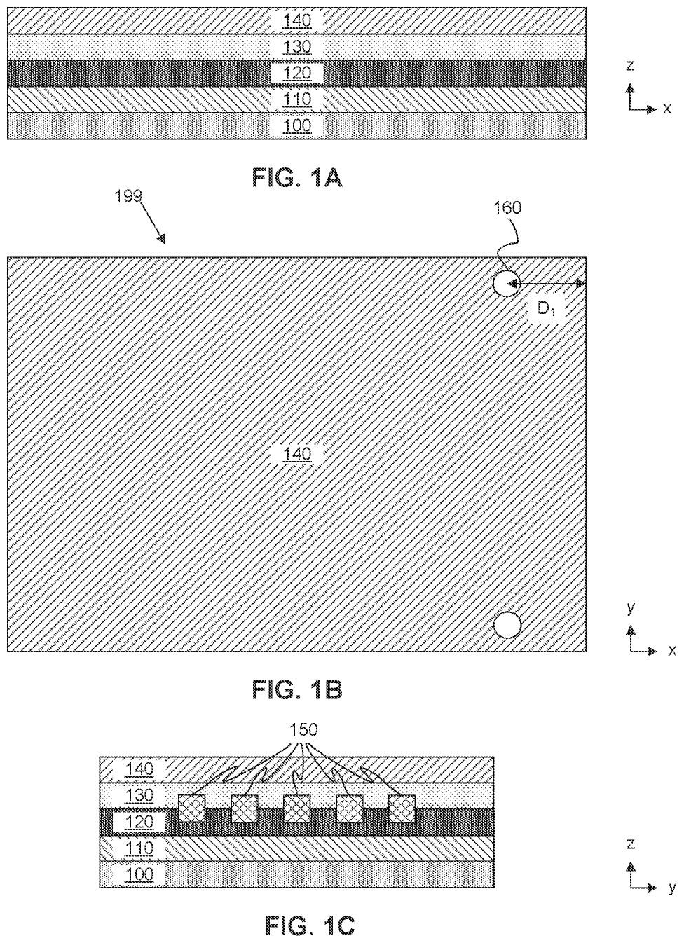

Referring to FIG. 1A-1C, different orientations of a flex stripline are depicted. FIG. 1A depicts a side-view of the flex stripline. FIG. 1B depicts a top-down view of the flex stripline. FIG. 1C depicts a cross-sectional view of the flex stripline. The flex stripline may contain a substrate 100, a first ground plane 110, a first dielectric 120, a second dielectric 130, a second ground plane 140, and conductive wires 150. Additionally, flex stripline may have guide holes 160 located near the end of the stripline, which may aid in aligning the stripline during splicing of multiple striplines.

The substrate 100 may include materials such as, for example, a polymeric material, glass, or silicon. This may enable the stripline to remain flexible, while also providing structural support to the elements located on the stripline.

The first ground plane 110 and the second ground plane 140 may include materials such as, for example, copper, niobium, or other conductive materials. In some embodiments, the material used for the first ground plane 110 and the second ground plane 140 may be the same material. In some embodiments, the thickness of the first ground plane 110 and the second ground plane 140 may be substantially similar.

The first dielectric 120 and the second dielectric 130 may include materials such as, for example, a polymeric material, oxides or nitrides. In some embodiments, the material used for the first dielectric 120 and the second dielectric 130 may be the same material. In some embodiments, the thickness of the first dielectric 120 and the second dielectric 130 may be substantially similar. However, in embodiments where the first dielectric 120 and the second dielectric 130 are different thicknesses, this may lead to an offset of the conductive wire from the center of the flex stripline 199.

The conductive wires 150 may include materials such as, for example, copper, niobium, or other conductive materials. In some embodiments, the material used for the conductive wires 150, the first ground plane 110 and the second ground plane 140 may be the same material. In some embodiments, the thickness of the first ground plane 110 and second ground plane 140 may be substantially similar.

The guide holes 160 may be located between the conductive wires and an edge of the stripline. The guide holes 160 may have a guide hole distance D₁ from the end of the stripline. The guide holes 160 may be any shape that enables two separate striplines to be aligned using the guide holes 160, such as, for example, laterally symmetric shapes.

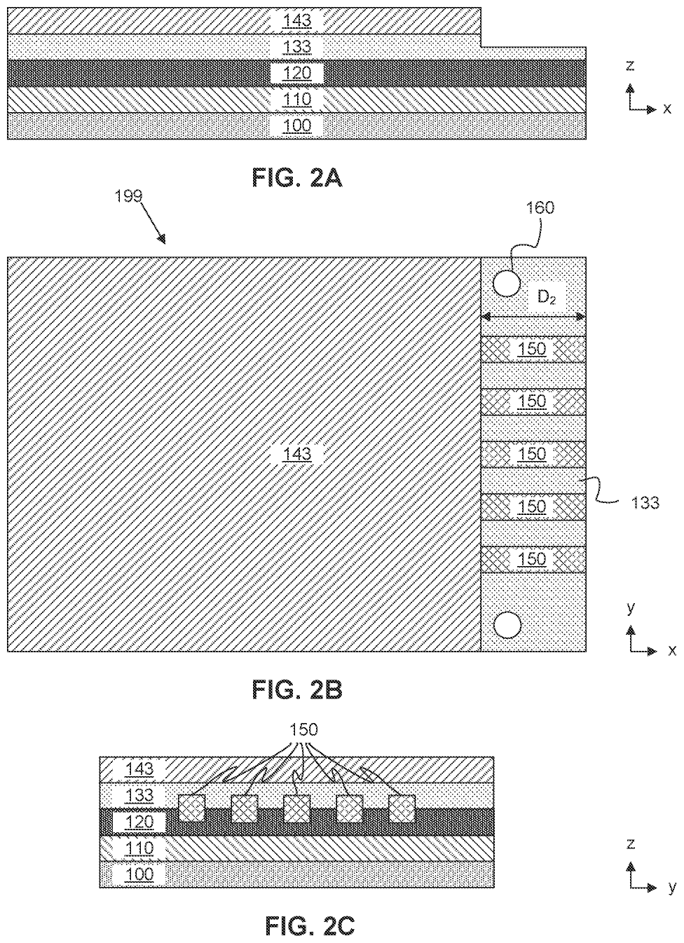

Referring to FIG. 2A-2C, during a first removal a portion of second ground plane 140 and second dielectric 130 may be removed to form second pulled back ground plane 143, second exposed dielectric 133, as well as exposing a top surface of the conductive wires 150. Removal may be performed using routing or laser ablation. Following removal, the top surface of the second exposed dielectric 133 may be coplanar with the top of the conductive wires. During this removal, material from the second ground plane 140 and second dielectric 130 may be removed a first removal distance D₂ from the end of the stripline. The first removal distance D₂ may be greater than the guide hole distance D₁. Additionally, the first removal may remove a portion of the second dielectric 130.

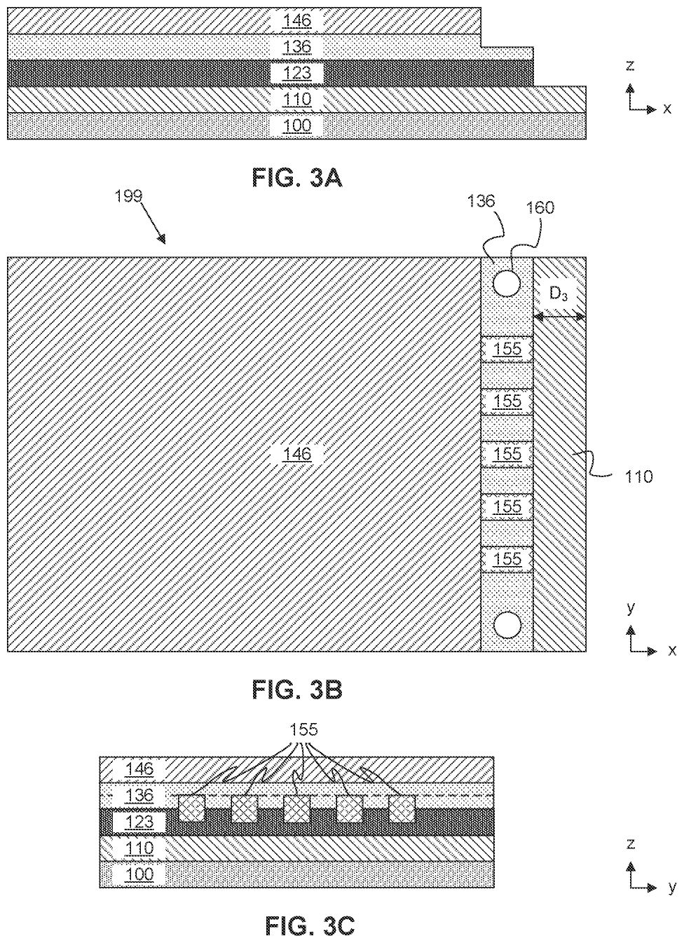

Referring to FIG. 3A-3C, during a second removal a portion of second exposed dielectric 133, conductive wire 150, and first dielectric 120 may be removed, forming second pulled back dielectric 136, first pulled back dielectric 123, and pulled back conductive wire 155, as well as exposing a top surface of first ground plane 120. Removal may be performed using routing or laser ablation. During this removal, material from the second ground plane 140 and second dielectric 130 may be removed a first removal distance D₂ from the end of the stripline. The second removal distance D₃ may be less than the guide hole distance D₁.

Referring to the ordering of FIG. 2A-2C and FIG. 3A-3C, while exposing the conductive wire 150 is depicted as occurring prior to exposing the first ground plane 110, the steps may be reversed. Additionally, optional embodiments may result in sloped surfaces of the removed portions of the stripline 199.

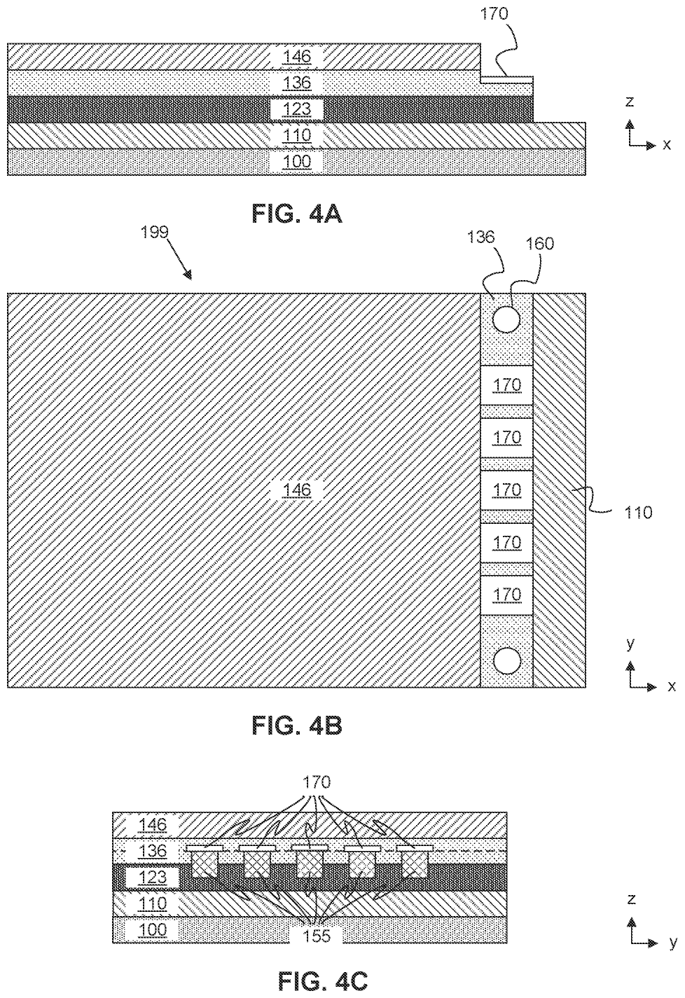

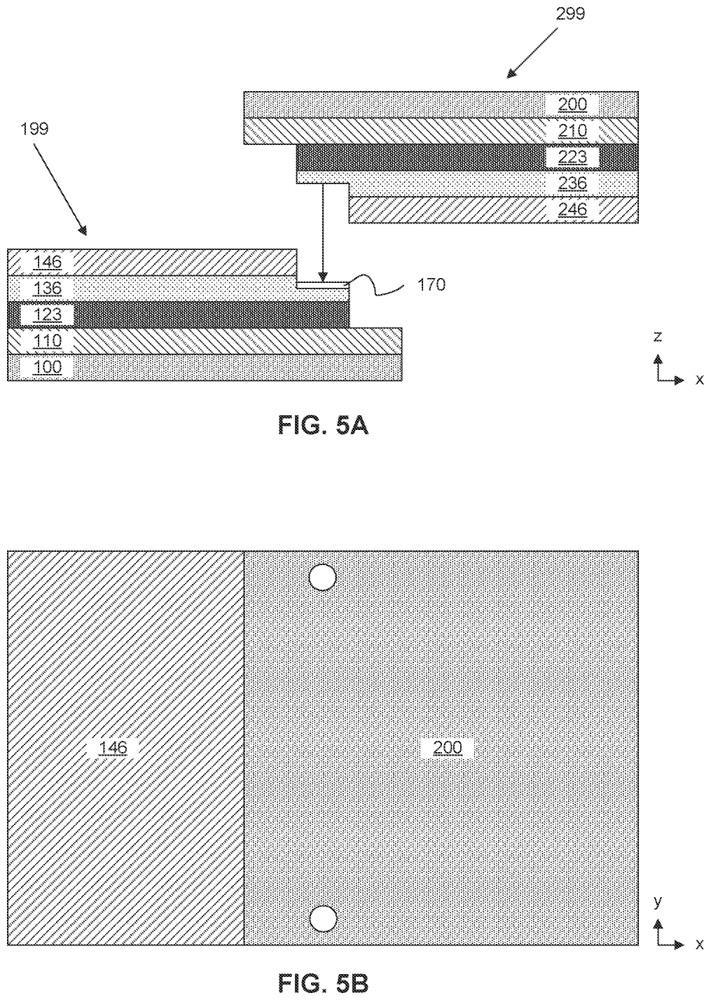

Referring to FIG. 4A-4C, a joining material 170 may be deposited on the top surface of the pulled back conductive wires 155. The joining material 170 is a conductive material capable of forming an electrical connection between the materials of pulled back conductive wires 155 and the second conductive wires 250 (discussed below in FIG. 5A-5B). This electrical connection may be the result of reflowing the joining material 170, or using the joining material as means for fusing the materials of pulled back conductive wires 155 and the second conductive wires 250. For example, the joining material 170 may include materials such as, for example, Sn, In, Pb, and combinations thereof. Additionally, the joining material 170 may be selected such that the reflow, or fusing, temperature of the joining material 170 is above a glass transition temperature of the material used for first dielectric 120 and second dielectric 130, which may enable the dielectric to fuse during reflow of the joining material 170.

Referring to FIG. 5A-5B, a second flexline 299 may be aligned with the first flexline 199. The substrate 200 may include similar materials and have similar dimensions as substrate 100. This enable the stripline to remain flexible, while also providing structural support to the elements located on the stripline.

The first ground plane 210 and the second ground plane 246 may include materials such as, for example niobium or other specialty conductive materials. In some embodiments, the material used for the first ground plane 210 and the second ground plane 246 may be the same material. In some embodiments, the thickness of the first ground plane 210 and the second ground plane 246 may be substantially similar.

The first dielectric 223 and the second dielectric 236 may include may include similar materials and dimensions to the first dielectric 123 and the second dielectric 136. In some embodiments, the material used for the first dielectric 223 and the second dielectric 236 may be the same material. In some embodiments, the thickness of the first dielectric 223 and the second dielectric 236 may be substantially similar.

The conductive wires 255 may include materials such as, for example, niobium. In some embodiments, the material used for the conductive wires 255, the first ground plane 210 and the second ground plane 246 may be the same material. In some embodiments, the thickness of the first ground plane 210 and second ground plane 246 may be substantially similar.

The guide holes 260 may be located between the conductive wires and an edge of the stripline. The guide holes 260 may have a guide hole distance D₁ from the end of the stripline. The guide holes 260 may be any shape that enables two separate striplines to be aligned using the guide holes 260, such as, for example, laterally symmetric shapes.

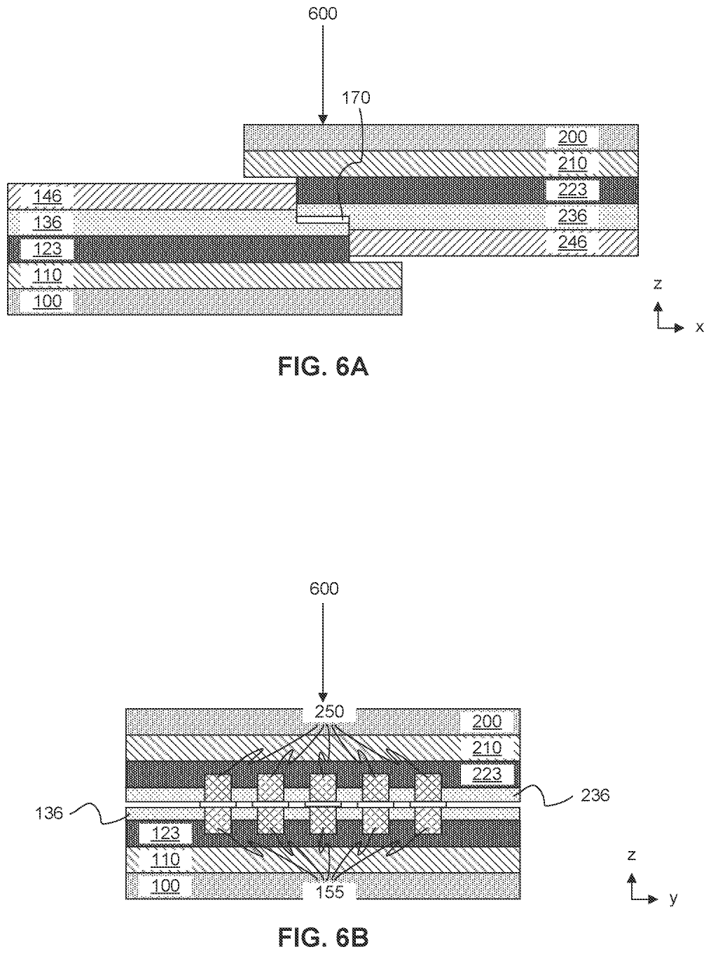

Referring to FIG. 6A-6B, the first flexline 199 is joined to the second flexline 299. In this step guide holes 160 are aligned with guide holes 260 to enable proper alignment of the first flexline 199 and the second flexline 299. After alignment, heat and a vertical pressure 600, as described above, may be applied to structure 120. This may allow for the joining material 170 to reflow to form a solid connection between the first conductive wire 155 and the second conductive wire 250. A thermal compression tool may be used to apply the temperature and the pressure to form the electrical connections between the first conductive wire 155 and the second conductive wire. A temperature in excess of the reflow, recrystallization, or reactive temperature of the junction material 170 may be used to form the requisite electromechanical connection. The reflow temperatures of common lead-free solder bumps may range from about 230° C. to about 260° C., and the temperatures used in the thermal compression tool may range from about 230° C. to about 400° C. The applied pressures 600 of the thermal compression tool may depend on the interconnect material and chip size. The vertical pressure 600 may range from about 6.0×10⁴ Pa to about 6.0×10⁵ Pa and may be applied using the thermal compression tool, although this pressure may be adjusted based on the contact area and materials to be interconnected. In one embodiment, a force ranging from about 5 N to about 50 N may be applied. The force too may be adjusted based on the contact area and materials to be interconnected.

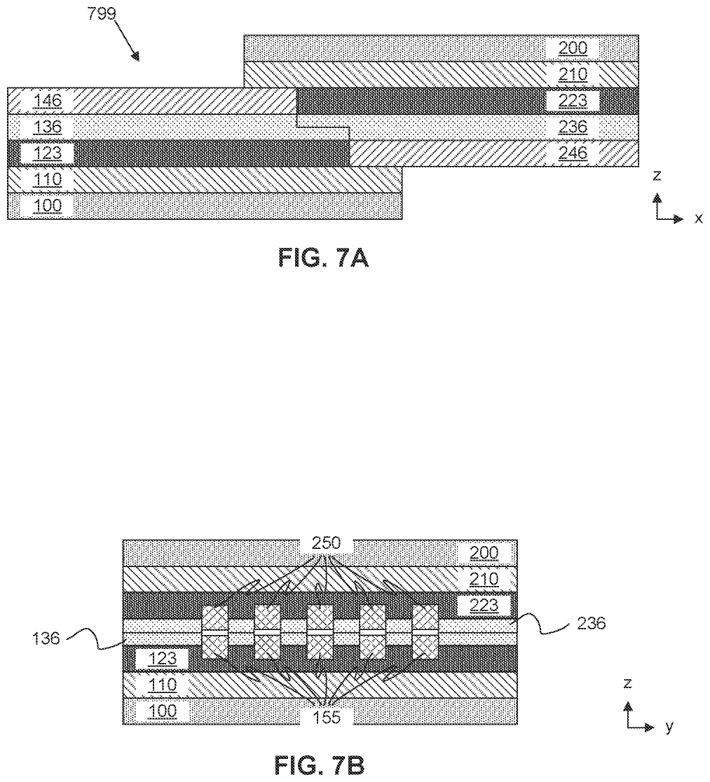

Referring to FIG. 7A-7B, a spliced stripline 799 may be the result of the steps depicted in the previous figures. The spliced stripline 799 may have a connection between the second ground plane 146 of the first stripline 199 and the first ground plane 210 of the second stripline 299. The spliced stripline 799 may have a connection between the first ground plane 110 of the first stripline 199 and the second ground plane 236 of the second stripline 299. Due to the joining process, the second dielectric layer 136 of the first stripline 199 and the second dielectric layer 236 of the second stripline 299 may fuse together, which may strengthen the connection at the joint between the two striplines. Additionally, the joining process may create an electrical joint 175 between 155 and 250. This joint may physically secure the first stipline 199 to the second stripline 299, while also not hindering the propagation of electromagnetic signals from 155 to 250 (or vice versa). In optional embodiments having a sloped exposed surfaces, the spliced stripline 799 may have a reduced thickness of the wire and ground plane at the junction, and in some embodiments may result in a uniform thickness of the wire and ground plane while passing through the junction.

What is claimed is:

1. A method of splicing striplines comprising:
removing a top groundplane and a top dielectric of a first stripline;
removing a top groundplane and a top dielectric of a second stripline;
applying a joining material to at least one signal line of the first stripline;
aligning the at least one signal line of the first stripline to at least one signal line of the second stripline; and
joining the first stripline to the second stripline.

2. The method of claim 1, wherein a material of the top ground plane of the first stripline comprises copper, and wherein a material of the top ground plane of the second stripline comprises niobium.

3. The method of claim 1, wherein a material of the top ground plane of the first stripline comprises niobium, and wherein a material of the top ground plane of the second stripline comprises niobium.

4. The method of claim 1, wherein a material of the at least one signal line of the first stripline comprises copper, and wherein a material of the at least one signal line of the second stripline comprises niobium.

5. The method of claim 1, wherein a material of the at least one signal line of the first stripline comprises niobium, and wherein a material of the at least one signal line of the second stripline comprises niobium.

6. The method of claim 1, wherein the joining material comprises a material selected from a group consisting of Sn, In, and Pb.

7. The method of claim 1, wherein joining the first stripline to the second stripline further comprises fusing a portion of the first dielectric with a portion of the second dielectric.

8. The method of claim 1, wherein a surface of an interface between the first stripline and the second stripline is substantially parallel to the bottom ground plane of the first stripline and the bottom ground plane of the second stripline.

9. The method of claim 1, wherein a surface of an interface between the first stripline and the second stripline is an acute angle with respect to the bottom ground plane of the first stripline and the bottom ground plane of the second stripline.

10. A structure comprising:
a first stripline comprising a signal line located between a top dielectric and a bottom dielectric, wherein the top dielectric is in contact with a top ground plane, and wherein the bottom dielectric is in contact with a bottom ground plane;
a second stripline; and
a joined portion connecting the first stripline to the second stripline, wherein at the joined portion the first stripline comprises the bottom ground plane, the bottom dielectric, and at least one signal line, and wherein at the joined portion the first stripline comprises the bottom ground plane, the bottom dielectric, and at least one signal line.

11. The structure of claim 10, wherein a material of the top ground plane of the first stripline comprises copper, and wherein a material of the top ground plane of the second stripline comprises niobium.

12. The structure of claim 10, wherein a material of the top ground plane of the first stripline comprises niobium, and wherein a material of the top ground plane of the second stripline comprises niobium.

13. The structure of claim 10, wherein a material of the at least one signal line of the first stripline comprises copper, and wherein a material of the at least one signal line of the second stripline comprises niobium.

14. The structure of claim 10, wherein a material of the at least one signal line of the first stripline comprises niobium, and wherein a material of the at least one signal line of the second stripline comprises niobium.

15. The structure of claim 10 further comprising a joining material located between the at least one signal line of the first stripline and the at least one signal line of the second stripline.

16. The structure of claim 15 wherein the joining material comprises a material selected from a group consisting of Sn, In, and Pb.

17. The structure of claim 10 further comprising a fused joint between the top dielectric of the first stripline and a top dielectric of the second stripline.

18. The structure of claim 10, wherein a surface of an interface between the first stripline and the second stripline is substantially parallel to the bottom ground plane of the first stripline and the bottom ground plane of the second stripline.

19. The structure of claim 10, wherein a surface of an interface between the first stripline and the second stripline is an acute angle with respect to the bottom ground plane of the first stripline and the bottom ground plane of the second stripline.

20. The structure of claim 10, wherein the top ground plane of the first stripline is in contact with the bottom contact of the second stripline, and wherein the bottom ground plane of the first stripline is in contact with the top contact of the second stripline.
